(19) United States
(12) Patent Application Publication
(10) Pub. No.: US 2026/0222506 A1
(43) Pub. Date: Jul. 30, 2026

(54) ELECTRONIC DEVICE CAPABLE OF CONTROLLING POWER SUPPLY TO STORAGE DEVICE

(71) Applicant: KYOCERA Document Solutions Inc., Osaka (JP)

(72) Inventors: Masaki SONE, Osaka (JP); Nobuyuki FUCHIMOTO, Osaka (JP); Masayuki GONDO, Osaka (JP); Izumi KUZE, Osaka (JP); Ho RI, Osaka (JP); Yukihiro SHIBATA, Osaka (JP); Tetsuya MATSUSAKA, Osaka (JP)

(73) Assignee: KYOCERA Document Solutions Inc., Osaka (JP)

(21) Appl. No.: 19/457,419

(22) Filed: Jan. 23, 2026

(30) Foreign Application Priority Data
Jan. 24, 2025 (JP) 2025-010936

(51) Int. Cl. H04N 1/00

(52) U.S. Cl. CPC H04N 1/00896; H04N 2201/0094

(57) ABSTRACT

When, in an electronic device operating in a second mode where a power supply to a storage device is off, an event leading to transition from the second mode to a first mode where the power supply to the storage device is allowed to be on occurs, a controller allows transition from the second to first mode. When a waiting period for which processing accompanying the event remains unexecuted reaches a threshold during operation in the first mode, the controller allows transition from the first to second mode. When, upon transition from the second to first mode, determining that an operating period in the previous second mode exceeds a criterion threshold, the controller sets the threshold to a first reference period. When determining that the operating period is not more than the criterion threshold, the controller sets the threshold to a second reference period longer than the first reference period.

### INCORPORATION BY REFERENCE

This application claims priority to Japanese Patent Application No. 2025-010936 filed on January 24, 2025, the entire contents of which are incorporated by reference herein.

### BACKGROUND

The present disclosure relates to electronic devices capable of performing on/off control of power supply to storage devices, such as SSDs (solid state drives) or HDDs (hard disk drives).

Recently, from the viewpoint of environmental protection, there have been demands for reduction in power consumption of various types of electronic devices, such as an image forming apparatus. To achieve this purpose, there is employed a technique for turning off the power supply to each of modules, including a storage device such as an SSD (solid state drive) or an HDD (hard disk drive), in an electronic device as necessary to allow the electronic device to transition to a power-saving mode.

As to a storage device, such as an SSD and an HDD, the number of times when the power supply to the storage device can be turned on operably without failure or the number of times when the power supply to the storage device can be turned off operably without failure (hereinafter, referred to as the "guaranteed power on-off times" as necessary) is guaranteed. For each of the electronic devices, the period of time during which the electronic device is operable without failure (hereinafter, referred to as the "product life" as necessary) is guaranteed. When the on-off operation of power supply to the storage device is repeated frequently, the number of turn-ons or turn-offs of the power supply to the storage device reaches the guaranteed power on-off times for the storage device in a short time and, as a result, the electronic device equipped with the storage device becomes inoperable before the product life is reached.

To cope with the above problem, generally, the value obtained by dividing the product life of an electronic device equipped with a storage device by the guaranteed power on-off times for the storage device is defined as a reference period and the power supply to the storage device is turned off when the period of time that has elapsed since the turn-on of the power supply to the storage device reaches the reference period. Thus, the possibility that the number of turn-ons or turn-offs of the power supply to the storage device reaches the guaranteed power on-off times for the storage device before the product life of the storage device has passed is reduced.

### SUMMARY

A technique improved over the aforementioned technique is proposed as one aspect of the present disclosure.

An electronic device according to an aspect of the present disclosure includes a storage device and a control device. The control device includes a processor and functions, through the processor executing a control program, as a controller that controls an operation of the storage device. The controller sets the electronic device to an operation mode selected from at least a first mode where a power supply to the storage device is allowed to be on and a second mode where the power supply to the storage device is off. Upon occurrence of a predetermined event leading to transition from the second mode to the first mode when the operation mode of the electronic device is the second mode, the controller allows the operation mode to transition from the second mode to the first mode. When, during operation of the electronic device in the first mode, a waiting period for which processing accompanying the event remains unexecuted reaches a predetermined threshold value, the controller allows the operation mode to transition from the first mode to the second mode. When the controller allows the operation mode to transition from the second mode to the first mode and determines that an operating period of the operation in the second mode just previous to transition to the first mode has exceeded a predetermined criterion threshold, the controller sets the threshold value to a predetermined value serving as a first reference period. When the controller allows the operation mode to transition from the second mode to the first mode and determines that the operating period of the operation in the second mode just previous to the transition to the first mode is not more than the criterion threshold, the controller sets the threshold value to a predetermined value serving as a second reference period longer than the first reference period.

An electronic device according to another aspect of the present disclosure includes a storage device and a control device. The control device includes a processor and functions, through the processor executing a control program, as a controller that controls an operation of the storage device. The controller sets the electronic device to an operation mode selected from at least a first mode where a power supply to the storage device is allowed to be on and a second mode where the power supply to the storage device is off. Upon occurrence of a predetermined event leading to transition from the second mode to the first mode when the operation mode of the electronic device is the second mode, the controller allows the operation mode to transition from the second mode to the first mode. When the controller allows the operation mode to make a transition from the second mode to the first mode and determines that a status of access to the storage device is a predetermined highly frequent access status where a frequency of access to the storage device is high, the controller turns the power supply to the storage device on upon the transition of the operation mode from the second mode to the first mode and thus runs the storage device. When the controller allows the operation mode to make a transition from the second mode to the first mode and determines that the status of access to the storage device is out of the highly frequent access status, the controller turns the power supply to the storage device on at a time when the storage device has been accessed after the transition of the operation mode from the second mode to the first mode and during subsequent operation of the electronic device in the first mode and thus runs the storage device.

### BRIEF DESCRIPTION OF THE DRAWINGS

FIG. 1 is a perspective view showing the appearance of an image forming apparatus as an electronic device according to a first embodiment which is an aspect of the present disclosure.

FIG. 2 is a functional block diagram showing an electrical configuration of the image forming apparatus shown in FIG. 1.

FIG. 3 is a flowchart showing the processing procedure of mode control processing of a controller shown in FIG. 2.

FIG. 4 is a flowchart showing the processing procedure of first control processing in the mode control processing of the controller in FIG. 3.

FIG. 5 is a flowchart showing the processing procedure of second control processing in the mode control processing of the controller in FIG. 3.

FIG. 6 is a portion of a flowchart showing the processing procedure of second control processing in mode control processing of a controller in a second embodiment.

FIG. 7 is the other portion of the flowchart showing the processing procedure of the second control processing in the mode control processing of the controller in the second embodiment.

### DETAILED DESCRIPTION

### First Embodiment

Hereinafter, a description will be given of an image forming apparatus 1 as an electronic device according to a first embodiment which is an aspect of the present disclosure with reference to the drawings.

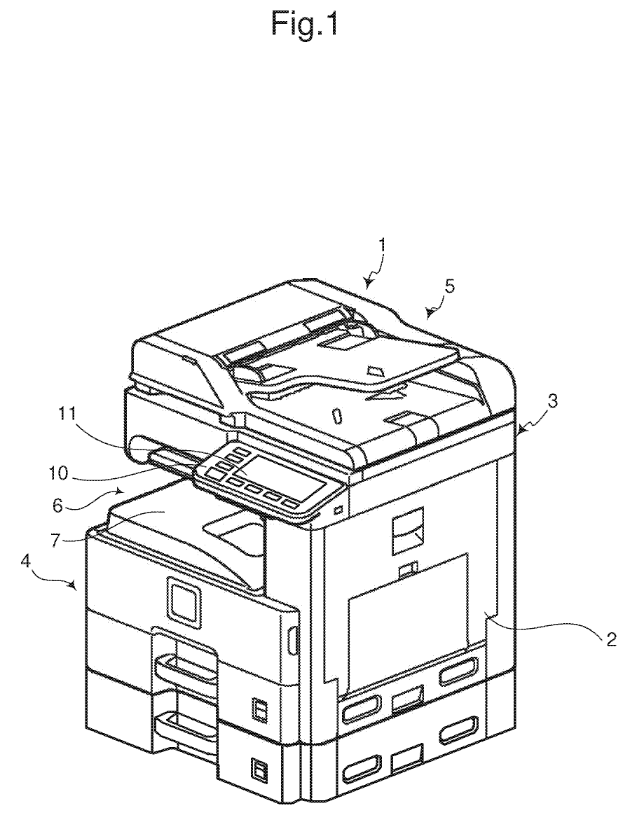

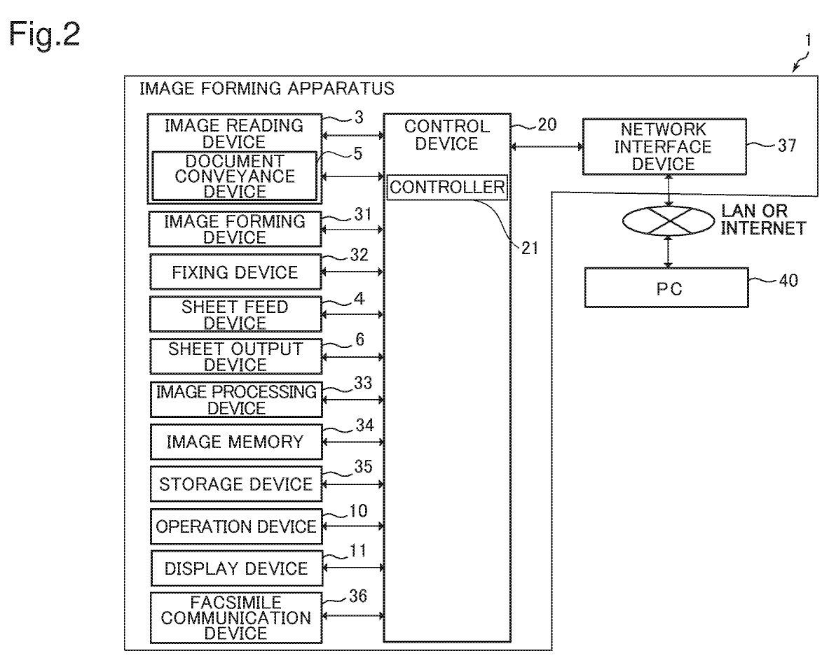

FIG. 1 is a perspective view showing the appearance of the image forming apparatus 1 as an electronic device according to the first embodiment which is an aspect of the present disclosure, and FIG. 2 is a functional block diagram showing an electrical configuration of the image forming apparatus 1 shown in FIG. 1. The image forming apparatus 1 is a multifunction peripheral having multiple functions, such as a facsimile function, a copy function, a print function, and a scan function. The image forming apparatus 1 is an example of the electronic device and the electronic device may be other than the image forming apparatus 1.

The image forming apparatus 1 includes an image reading device 3, a sheet feed device 4, a sheet output device 6, an operation device 10, a display device 11, an image forming device 31, a fixing device 32, an image processing device 33, an image memory 34, a storage device 35, a facsimile communication device 36, a network interface device 37, a control device 20, and so on. A housing 2 of the image forming apparatus 1 accommodates a plurality of devices, such as the image reading device 3, the image forming device 31, the fixing device 32, and the sheet feed device 4, for the purpose of implementing various functions.

The image reading device 3 is an ADF (auto document feeder) including: a document conveyance device 5 that conveys an original document; and a scanner that optically reads an original document conveyed by the document conveyance device 5 or an original document placed on an unshown original glass plate. The image reading device 3 irradiates the original document with light from a lighting device included therein, receives on a CCD sensor included therein light reflected from the original document to read an image of the original document, and thus acquires image data representing the image of the original document.

The image processing device 33 includes an image processing circuit and applies image processing to image data acquired by the image reading device 3 or image data sent from a personal computer, another facsimile device or the like connected via a network.

The image memory 34 includes a region that temporarily stores image data obtained by image processing by the image processing device 33. For example, the image memory 34 temporarily stores image data to be subjected to image formation by the image forming device 31.

The image forming device 31 includes a photosensitive drum, a charging device, an exposure device, a developing device, and a transfer device. The image forming device 31 forms, based on image data temporarily stored in the image memory 34, a toner image on a recording paper sheet fed from the sheet feed device 4.

The fixing device 32 performs fixation processing by applying heat and pressure to the recording paper sheet with a toner image formed thereon by the image formation processing of the image forming device 31 to fix the toner image on the recording paper sheet by heat and pressure. After being subjected to the fixation processing by the fixing device 32, the recording paper sheet with an image formed thereon is ejected to the sheet output device 6. The sheet output device 6 includes a sheet output tray 7 on which ejected recording paper sheets with images formed thereon are to be put. The sheet feed device 4 picks up recording paper sheets accommodated in sheet feed cassettes or recording paper sheets placed on a manual feed tray sheet by sheet and feeds the sheet toward the image forming device 31.

The operation device 10 and the display device 11 are disposed in the vicinity of the image reading device 3 and at the front of the image forming apparatus 1. The display device 11 includes a display panel and so on and displays, under the control of a controller 21, various screens including a GUI (graphic user interface) screen, such as a home screen, a login screen, a copy screen, a send screen, and a job history screen, for use by the user that does various operations for various functions of the image forming apparatus 1. The operation device 10 includes a touch panel overlaid on the display panel of the display device 11, a keypad, and so on and accepts instructions input by the user as to processing for various functions executable by the image forming apparatus 1.

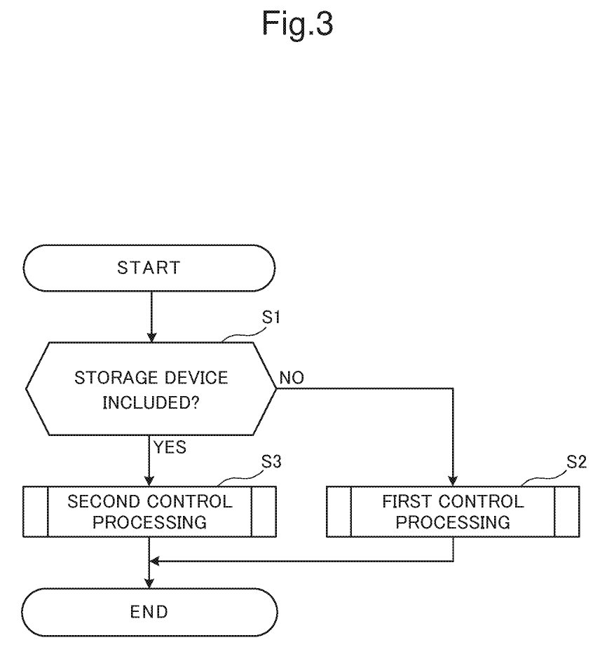

The storage device 35 is a large-capacity storage device that stores various types of data and various control programs for use in implementing operations of the image forming apparatus 1. In this embodiment, the storage device 35 stores a mode control program for use when the control device 20 executes mode control processing the processing procedure of which is shown in FIGS. 3 to 5. In a second embodiment to be described later, the storage device 35 stores a mode control program for use when the control device 20 executes mode control processing the processing procedure of which is shown in FIGS. 3, 4, 6 and 7.

The storage device 35 is a storage device, such as an HDD (hard disk drive) or an SSD (solid state drive), in which the number of times when the power supply to the storage device can be turned on operably without failure or the number of times when the power supply to the storage device can be turned off operably without failure is guaranteed. The storage device 35 is an example of the storage device defined in CLAIMS.

The facsimile communication device 36 is a facsimile communication mechanism that connects to public lines to send and receive image data via the public lines. The network interface device 37 is an interface with a LAN or an internetwork. The controller 21 to be described later performs data communication through the network interface device 37 with a personal computer 40 or the like on the LAN or the internetwork.

The control device 20 includes a processor, a RAM (random access memory), a ROM (read only memory), and so on. The processor is, for example, a CPU (central processing unit), an MPU (micro processing unit) or an ASIC (application specific integrated circuit). The control device 20 is electrically connected to the image reading device 3 with the document conveyance device 5, the sheet feed device 4, the sheet output device 6, the operation device 10, the display device 11, the image forming device 31, the fixing device 32, the image processing device 33, the image memory 34, the storage device 35, the facsimile communication device 36, the network interface device 37, and so on.

The control device 20 includes a controller 21. The control device 20 functions as the controller 21 when the processor operates in accordance with a control program, such as a mode control program, stored in the storage device 35. The controller 21 controls the operations of components of the image forming apparatus 1. However, the controller 21 may not necessarily be implemented by the operation of the control device 20 in accordance with the control program, such as the mode control program, and may be constituted by a hardware circuit. Hereinafter, the same applies to the other embodiments unless otherwise specified.

The components of the image forming apparatus 1 are connected to an unshown power source and operated by electricity provided by the power source. In this embodiment, the controller 21 controls the respective power supplies to the components of the image forming apparatus 1.

In the first embodiment, the image forming apparatus 1 has three operation modes: a normal mode, a first power-saving mode, and a second power-saving mode.

The normal mode is an operation mode in which processing for various functions of the image forming apparatus 1 can be quickly executed and, for this purpose, the power supplies to the components (including the control device 20 (the controller 21), the image reading device 3 with the document conveyance device 5, the sheet feed device 4, the sheet output device 6, the operation device 10, the display device 11, the image forming device 31, the fixing device 32, the image processing device 33, the image memory 34, the storage device 35, the facsimile communication device 36, and the network interface device 37) are on.

The first power-saving mode is an operation mode in which the power consumption of the image forming apparatus 1 is reduced by turning off, among the power supplies to the components of the image forming apparatus 1, a power supply to the display device 11 as predetermined and turning on the power supplies to the components other than the display device 11. The first power-saving mode in the first embodiment is a mode in which the power supply to the storage device 35 as the storage device defined in CLAIMS is allowed to be on, wherein the power supply to the storage device 35 is normally on. The first power-saving mode in the second embodiment is a mode in which the power supply to the storage device 35 as the storage device defined in CLAIMS is allowed to be on, wherein in some cases the power supply to the storage device 35 is on and in other cases the power supply to the storage device 35 is off. The first power-saving mode is an example of the first mode defined in CLAIMS.

The second power-saving mode is an operation mode in which the power consumption of the image forming apparatus 1 is reduced more than the first power-saving mode by turning on, among the power supplies to the components of the image forming apparatus 1, the power supplies to predetermined components, such as the control device 20 (the controller 21), and turning off the power supplies to the other predetermined components, such as the display device 11 and the storage device 35. The second power-saving mode is an example of the second mode defined in CLAIMS.

The controller 21 controls the operation of the storage device 35.

The controller 21 sets the image forming apparatus 1 to either one of the normal mode, the first power-saving mode, and the second power-saving mode.

Upon occurrence of a predetermined event leading to transition of the operation mode of the image forming apparatus 1 from the second power-saving mode to the first power-saving mode when the operation mode of the image forming apparatus 1 is the second power-saving mode, the controller 21 allows the operation mode to transition from the second power-saving mode to the first power-saving mode.

When, during operation of the image forming apparatus 1 in the first power-saving mode, the waiting period for which processing accompanying the above event remains unexecuted reaches a predetermined threshold value, the controller 21 allows the operation mode to transition from the first power-saving mode back to the second power-saving mode.

When the controller 21 allows the operation mode to transition from the second power-saving mode to the first power-saving mode and determines that the operating period of the operation in the second power-saving mode just previous to the transition to the first power-saving mode has exceeded a predetermined criterion threshold (a second criterion threshold in this embodiment), the controller 21 sets the threshold value to a predetermined value serving as a first reference period (a 2-1-st timer period in this embodiment). When the controller 21 allows the operation mode to transition from the second power-saving mode to the first power-saving mode and determines that the operating period of the operation in the second power-saving mode just previous to the transition to the first power-saving mode is not more than the criterion threshold (the second criterion threshold in this embodiment), the controller 21 sets the threshold value to a predetermined value serving as a second reference period (a 2-2-nd timer period in this embodiment) longer than the first reference period.

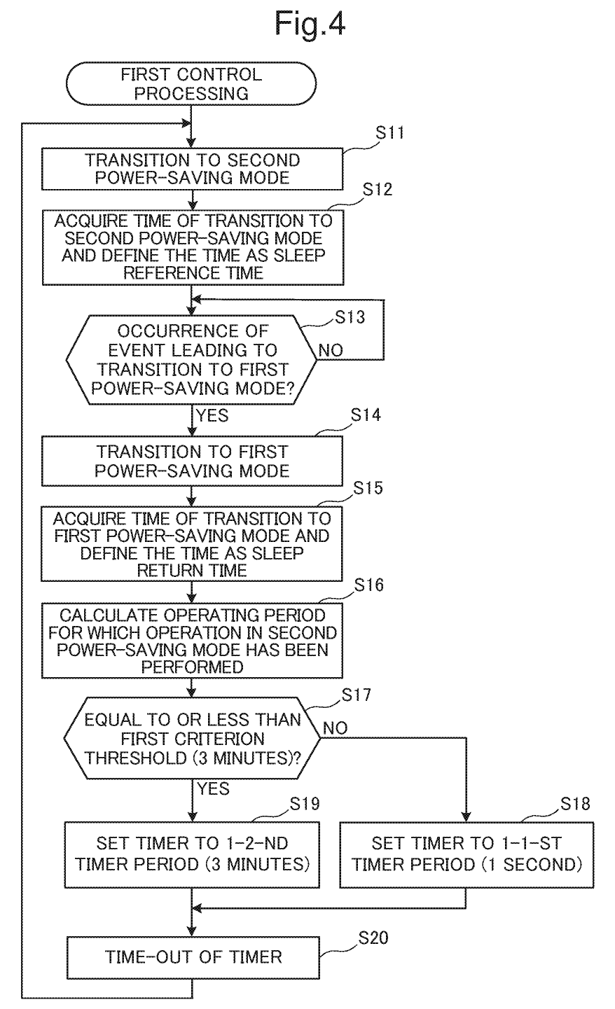

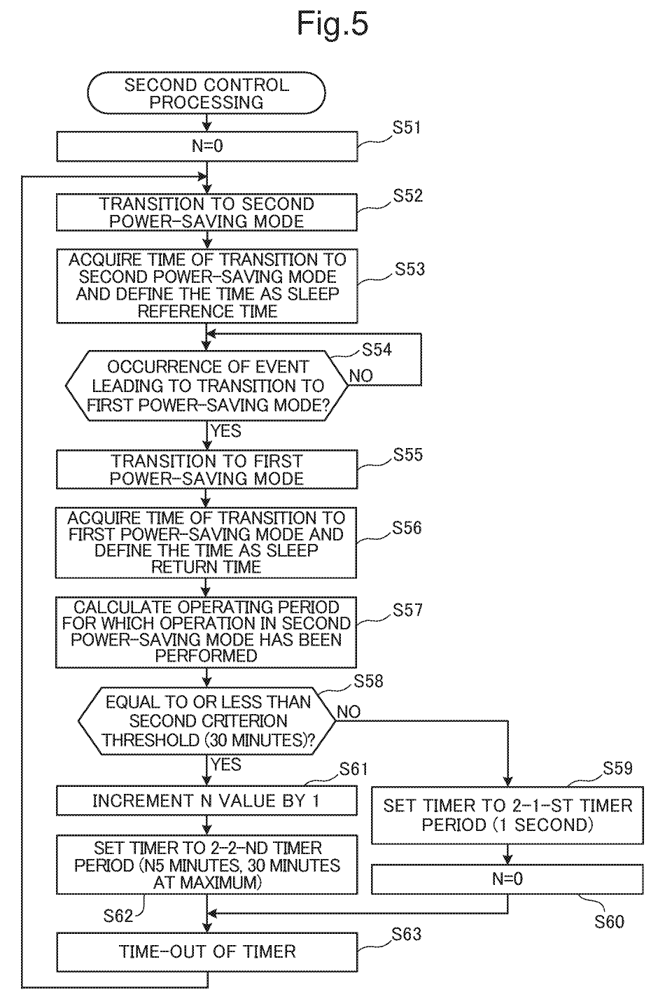

FIG. 3 is a flowchart showing the processing procedure of mode control processing of the controller 21 shown in FIG. 2. FIG. 4 is a flowchart showing the processing procedure of first control processing in the mode control processing of the controller 21 in FIG. 3. FIG. 5 is a flowchart showing the processing procedure of second control processing in the mode control processing of the controller 21 in FIG. 3. When executing a mode control program stored in the storage device 35, the control device 20 functions as the controller 21 that performs the mode control processing the processing procedure of which is shown in FIGS. 3 to 5.

When, during operation of the image forming apparatus 1 in the normal mode, a predetermined event leading to transition from the normal mode to the second power-saving mode occurs, such as an event that image formation processing remains unexecuted on the image forming apparatus 1 over a predetermined period of time, the controller 21 determines whether or not the image forming apparatus 1 includes a storage device, such as an HDD or an SSD, that meets a requirement that the number of times when the power supply to the storage device can be turned on operably without failure or the number of times when the power supply to the storage device can be turned off operably without failure is guaranteed (step S1).

When determining that the image forming apparatus 1 does not include any storage device that meets the requirement (NO in S1), the controller 21 executes the first control processing shown in FIG. 4 (step S2).

On the other hand, when determining that the image forming apparatus 1 includes a storage device that meets the requirement (YES in S1), the controller 21 executes the second control processing shown in FIG. 5 (step S3).

When, during operation of the image forming apparatus 1 in the first power-saving mode or the second power-saving mode, a predetermined event leading to transition from the first power-saving mode or the second power-saving mode to the normal mode occurs, such as an event that the operation device 10 has been operated, the controller 21 terminates the mode control processing the processing procedure of which is shown in FIGS. 3 to 5, allows the operation mode of the image forming apparatus 1 to transition from the first power-saving mode or the second power-saving mode to the normal mode, and turns on, among the power supplies to the components of the image forming apparatus 1, the power supplies to components in which the power supplies thereto are off.

In the first control processing shown in FIG. 4, the controller 21 allows the operation mode of the image forming apparatus 1 to transition from the normal mode or the first power-saving mode to the second power-saving mode and, as for, among predetermined components of the image forming apparatus 1 the power supplies to which are to be off in the second power-saving mode, components the power supplies to which are on, the controller 21 turns the power supplies to the components from on to off (step S11).

Subsequently to the processing in step S11, the controller 21 acquires information about the point in time when the operation mode has transitioned to the second power-saving mode and defines the point in time as a sleep reference time (step S12).

Subsequently to step S12, the controller 21 determines whether or not a predetermined event leading to transition from the second power-saving mode to the first power-saving mode (hereinafter, the event is referred to as a "second to first transition event" when appropriate) has occurred, such as an event that a print job has been entered (step S13). When in the determination processing in step S13 the controller 21 determines that no predetermined event (second to first transition event) has occurred (NO in S13), the controller 21 executes the processing in step S13.

When in the determination processing in step S13 the controller 21 determines that the predetermined event (second to first transition event) has occurred (YES in S13), the controller 21 allows the operation mode of the image forming apparatus 1 to transition from the second power-saving mode to the first power-saving mode and, as for, among components of the image forming apparatus 1 the power supplies to which are to be on in the first power-saving mode, components the power supplies to which are off, the controller 21 turns the power supplies to the components from off to on to run the components (step S14).

Subsequently to the processing in step S14, the controller 21 acquires information about the point in time when the operation mode has transitioned to the first power-saving mode and defines the point in time as a sleep return time (step S15).

Subsequently to step S15, the controller 21 calculates the operating period during which the image forming apparatus 1 has operated in the second power-saving mode from the sleep reference time to the sleep return time (i.e., the operating period = (the sleep return time) minus (the sleep reference time)) (step S16).

Subsequently to step S16, the controller 21 determines whether or not the operating period of the operation in the second power-saving mode is equal to or less than a predetermined first criterion threshold (three (minutes) in this embodiment) (step S17).

When in the determination processing in step S17 the controller 21 determines that the operating period is neither equal to nor less than the first criterion threshold (NO in S17), the controller 21 sets the timer to a predetermined 1-1-st timer period (1 (second) in this embodiment) (step S18) and goes to the processing in step S20.

On the other hand, when in the determination processing in step S17 the controller 21 determines that the operating period is equal to or less than the first criterion threshold (YES in S17), the controller 21 sets the timer to a predetermined 1-2-nd timer period (three (minutes) in this embodiment) longer than the 1-1-st timer period (step S19) and goes to the processing in step S20.

The controller 21 starts the timer at the start of the waiting period during which it has not yet executed the processing accompanying the second to first transition event. Then, when the 1-1-st timer period set in step S18 or the 1-2-nd timer period set in step S19 has passed to reach a time-out (step S20), the controller 21 goes back to the processing in step S11 and, in step S11, allows the operation mode of the image forming apparatus 1 to transition from the first power-saving mode back to the second power-saving mode and, as for, among the predetermined components of the image forming apparatus 1 the power supplies to which are to be off in the second power-saving mode, the components the power supplies to which are on, the controller 21 turns the power supplies to the components from on to off. Furthermore, when a second to first transition event occurs, the controller 21 resets the timer and sets the 1-1-st timer period or the 1-2-nd timer period anew.

In the second control processing shown in FIG. 5, the controller 21 sets N=0 (step S51) and goes to the processing in step S52.

The controller 21 allows the operation mode of the image forming apparatus 1 to transition from the normal mode or the first power-saving mode to the second power-saving mode and, as for, among predetermined components of the image forming apparatus 1 the power supplies to which are to be off in the second power-saving mode, components the power supplies to which are on (such as the storage device 35 as the storage device defined in CLAIMS), the controller 21 turns the power supplies to the components from on to off (step S52).

Subsequently to the processing in step S52, the controller 21 acquires information about the point in time when the operation mode has transitioned to the second power-saving mode and defines the point in time as a sleep reference time (step S53).

Subsequently to step S53, the controller 21 determines whether or not a predetermined event leading to transition from the second power-saving mode to the first power-saving mode (a second to first transition event) has occurred (step S54). When in the determination processing in step S54 the controller 21 determines that no predetermined event (second to first transition event) has occurred (NO in S54), the controller 21 executes the processing in step S54.

When in the determination processing in step S54 the controller 21 determines that the predetermined event (second to first transition event) has occurred (YES in S54), the controller 21 allows the operation mode of the image forming apparatus 1 to transition from the second power-saving mode to the first power-saving mode and, as for, among components of the image forming apparatus 1 the power supplies to which are to be on in the first power-saving mode, components the power supplies to which are off (such as the storage device 35 as the storage device defined in CLAIMS), the controller 21 turns the power supplies to the components (such as the storage device 35) from off to on to run the components (step S55).

Subsequently to the processing in step S55, the controller 21 acquires information about the point in time when the operation mode had transitioned to the first power-saving mode and defines the point in time as a sleep return time (step S56).

Subsequently to the processing in step S56, the controller 21 calculates the operating period during which the image forming apparatus 1 has operated in the second power-saving mode from the sleep reference time to the sleep return time (i.e., the operating period = (the sleep return time) minus (the sleep reference time)) (step S57).

Subsequently to step S57, the controller 21 determines whether or not the operating period of the operation in the second power-saving mode is equal to or less than the predetermined second criterion threshold (30 (minutes) in this embodiment) (step S58). The second criterion threshold is an example of the criterion threshold defined in CLAIMS.

When in the determination processing in step S58 the controller 21 determines that the operating period is neither equal to nor less than the second criterion threshold (NO in S58), the controller 21 sets the timer to the predetermined 2-1-st timer period (1 (second) in this embodiment) (step S59). The 2-1-st timer period is an example of the first reference period defined in CLAIMS. Subsequently to the processing in S59, the controller 21 sets N=0 (step S60) and goes to the processing in step S63.

On the other hand, when in the determination processing in step S58 the controller 21 determines that the operating period is equal to or less than the second criterion threshold (YES in S58), the controller 21 increments the value of N by 1 (step S61). Subsequently, the controller 21 sets the timer to the predetermined 2-2-nd timer period (N×5 (minutes) in this embodiment) longer than the 2-1-st timer period (step S62) and goes to the processing in step S63. However, when in step S62 N×5 (minutes) exceeds 30 (minutes), the controller 21 sets the 2-2-nd timer period to 30 minutes. The 2-2-nd timer period is an example of the second reference period defined in CLAIMS.

The controller 21 starts the timer at the start of the waiting period during which it has not yet executed the processing accompanying the second to first transition event. Then, when the 2-1-st timer period set in step S59 or the 2-2-nd timer period set in step S62 has passed to reach a time-out (step S63), the controller 21 goes back to the processing in step S52 and, in step S52, allows the operation mode of the image forming apparatus 1 to transition from the first power-saving mode back to the second power-saving mode and, as for, among the predetermined components of the image forming apparatus 1 the power supplies to which are to be off in the second power-saving mode, the components the power supplies to which are on (such as the storage device 35 as the storage device defined in CLAIMS), the controller 21 turns the power supplies to the components from on to off. Furthermore, when a second to first transition event occurs, the controller 21 resets the timer and sets the 2-1-st timer period or the 2-2-nd timer period anew.

When, upon transition from the second power-saving mode to the first power-saving mode, the operating period of the operation of the image forming apparatus 1 in the second power-saving mode just previous to the transition to the first power-saving mode is not more than the second criterion threshold, the frequency of use of the image forming apparatus 1 can be assumed to be high. When, upon transition from the second power-saving mode to the first power-saving mode, the operating period of the operation of the image forming apparatus 1 in the second power-saving mode just previous to the transition to the first power-saving mode is more than the second criterion threshold, the frequency of use of the image forming apparatus 1 can be assumed to be low.

In the first embodiment, the waiting period (the 2-2-nd timer period) during which the processing accompanying the second to first transition event in the first power-saving mode after transition from the second power-saving mode remains unexecuted in the case where the operating period in the second power-saving mode just previous to the transition is not more than the second criterion threshold, in which case the frequency of use of the image forming apparatus 1 can be assumed to be high, is set to be longer than the waiting period (the 2-1-st timer period) during which the processing accompanying the second to first transition event in the first power-saving mode after transition from the second power-saving mode remains unexecuted in the case where the operating period in the second power-saving mode just previous to the transition is more than the second criterion threshold, in which case the frequency of use of the image forming apparatus 1 can be assumed to be low.

Thus, in the case where the frequency of use of the image forming apparatus 1 can be assumed to be high, the frequency of turning from on to off of the power supply to the storage device 35 can be reduced and, as a result, the life of the image forming apparatus 1 equipped with the storage device 35 can be extended.

In addition, in the case where the frequency of use of the image forming apparatus 1 can be assumed to be low, the ratio of the operating period in the second power-saving mode to the total operating period in the first and second power-saving modes can be increased and, as a result, the power consumption of the image forming apparatus 1 can be reduced.

### Second Embodiment

Hereinafter, a description will be given of an image forming apparatus 1 as an electronic device according to a second embodiment which is another aspect of the present disclosure with reference to the drawings.

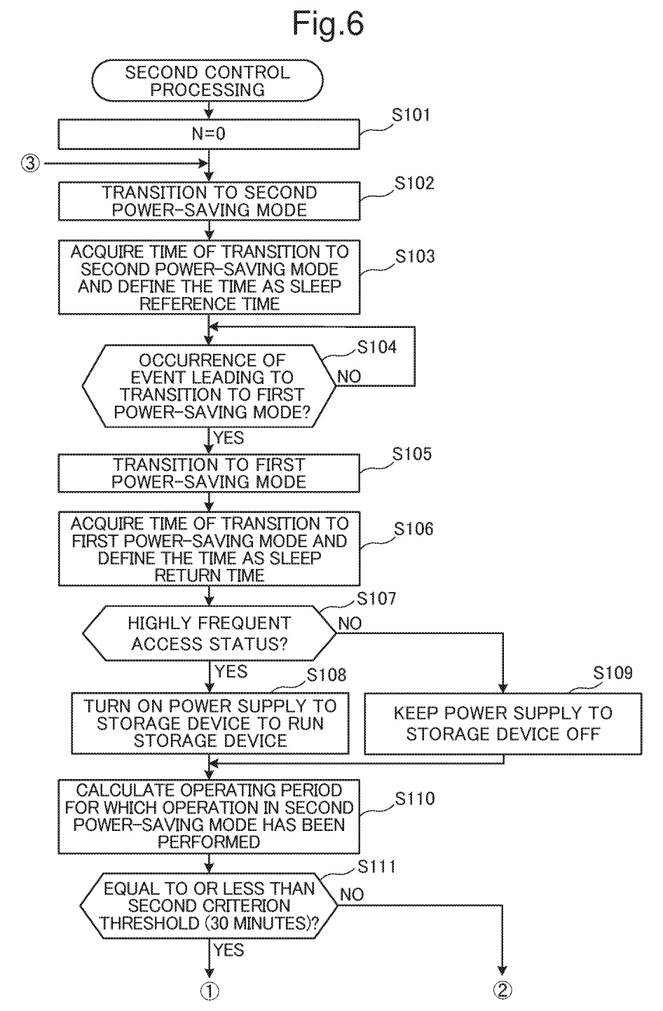

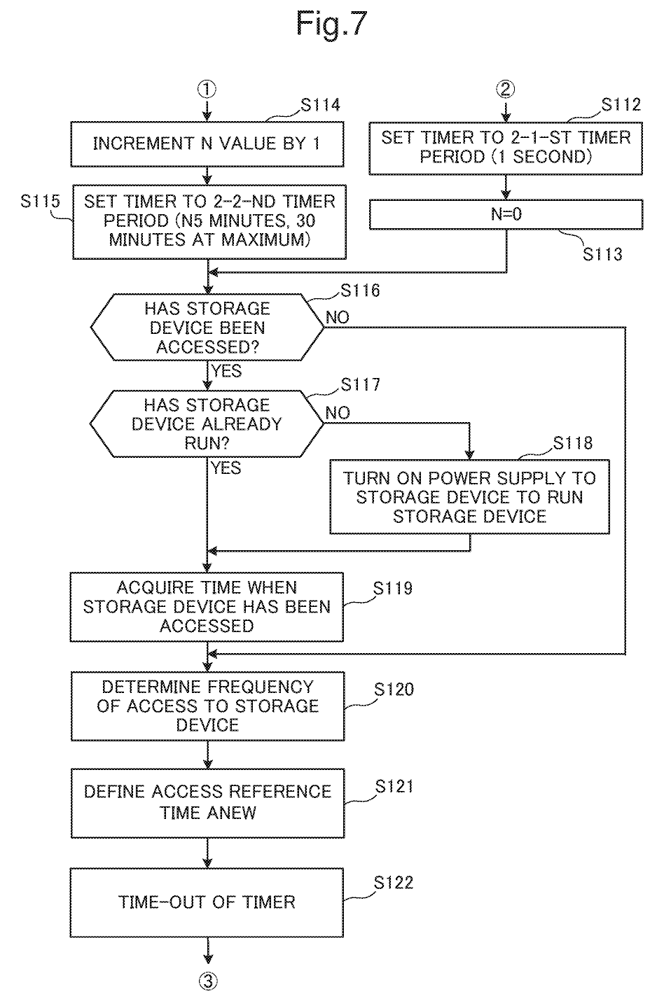

In the image forming apparatus 1 according to the first embodiment, the power supply to the storage device 35 is turned on upon transition of the image forming apparatus 1 from the second power-saving mode to the first power-saving mode. Unlike this, the image forming apparatus 1 according to the second embodiment determines, in consideration of the status of access to the storage device 35, the timing with which the power supply to the storage device 35 is turned on based on the transition of the image forming apparatus 1 from the second power-saving mode to the first power-saving mode. The image forming apparatus 1 according to the second embodiment is different from the image forming apparatus 1 according to the first embodiment in that second control processing the processing procedure of which is shown as a flowchart in FIGS. 6 and 7 is executed differently from the second control processing which is executed by the image forming apparatus 1 according to the first embodiment and the processing procedure of which is as a flowchart shown in FIG. 5, and the rest is the same as in the image forming apparatus 1 according to the first embodiment.

The controller 21 sets the image forming apparatus 1 to either one of the normal mode, the first power-saving mode, and the second power-saving mode.

Upon occurrence of a predetermined event leading to transition of the operation mode of the image forming apparatus 1 from the second power-saving mode to the first power-saving mode when the operation mode of the image forming apparatus 1 is the second power-saving mode, the controller 21 allows the operation mode to transition from the second power-saving mode to the first power-saving mode.

When, during operation of the image forming apparatus 1 in the first power-saving mode, the waiting period for which processing accompanying the above event remains unexecuted reaches a predetermined threshold value, the controller 21 allows the operation mode to transition from the first power-saving mode back to the second power-saving mode.

When the controller 21 allows the operation mode to transition from the second power-saving mode to the first power-saving mode and determines that the operating period of the operation in the second power-saving mode just previous to the transition to the first power-saving mode has exceeded a predetermined criterion threshold (a second criterion threshold in this embodiment), the controller 21 sets the threshold value to a predetermined value serving as a first reference period (a 2-1-st timer period in this embodiment). When the controller 21 allows the operation mode to transition from the second power-saving mode to the first power-saving mode and determines that the operating period of the operation in the second power-saving mode just previous to the transition to the first power-saving mode is not more than the criterion threshold (the second criterion threshold in this embodiment), the controller 21 sets the threshold value to a predetermined value serving as a second reference period (a 2-2-nd timer period in this embodiment) longer than the first reference period.

When, upon transition of the operation mode from the second power-saving mode to the first power-saving mode, the controller 21 determines that the status of access to the storage device 35 as the storage device defined in CLAIMS is a predetermined highly frequent access status where the frequency of access to the storage device 35 is high, the controller 21 turns the power supply to the storage device 35 on upon transition of the operation mode from the second power-saving mode to the first power-saving mode and thus runs the storage device 35. On the other hand, when, upon transition of the operation mode from the second power-saving mode to the first power-saving mode, the controller 21 determines that the status of access to the storage device 35 is out of the highly frequent access status, the controller 21 turns the power supply to the storage device 35 on at the time when the storage device 35 has been accessed after the transition of the operation mode from the second power-saving mode to the first power-saving mode and during subsequent operation of the image forming apparatus 1 in the first power-saving mode and thus runs the storage device 35.

During the operation of the image forming apparatus 1 in the first power-saving mode as a result of transition from the second power-saving mode to the first power-saving mode, the controller 21 detects a time interval to a first access to the storage device 35 as the storage device defined in CLAIMS since the transition to the first power-saving mode. When the time interval detected during the operation in the first power-saving mode as the result of transition from the second power-saving mode to the first power-saving mode is not more than a predetermined value, the controller 21 determines that the frequency of access to the storage device is high. When the detected time interval is more than the predetermined value, the controller 21 determines that the frequency of access to the storage device is low.

FIG. 6 is a portion of a flowchart showing the processing procedure of second control processing in mode control processing of the controller in the second embodiment. FIG. 7 is the other portion of the flowchart showing the processing procedure of the second control processing in the mode control processing of the controller in the second embodiment. When executing a mode control program stored in the storage device 35, the control device 20 functions as the controller 21 that performs the mode control processing the processing procedure of which is shown in FIGS. 3, 4, 6, and 7.

In the second control processing shown in FIGS. 6 and 7, the controller 21 sets N=0 (step S101) and goes to the processing in step S102.

The controller 21 allows the operation mode of the image forming apparatus 1 to transition from the normal mode or the first power-saving mode to the second power-saving mode and, as for, among predetermined components of the image forming apparatus 1 the power supplies to which are to be off in the second power-saving mode, components the power supplies to which are on (such as the storage device 35 as the storage device defined in CLAIMS), the controller 21 turns the power supplies to the components from on to off (step S102).

Subsequently to the processing in step S102, the controller 21 acquires information about the point in time when the operation mode has transitioned to the second power-saving mode and defines the point in time as a sleep reference time (step S103).

Subsequently to step S103, the controller 21 determines whether or not a predetermined event leading to transition from the second power-saving mode to the first power-saving mode (a second to first transition event) has occurred (step S104). When in the determination processing in step S104 the controller 21 determines that no predetermined event (second to first transition event) has occurred (NO in S104), the controller 21 executes the processing in step S104.

When in the determination processing in step S104 the controller 21 determines that the predetermined event (second to first transition event) has occurred (YES in S104), the controller 21 allows the operation mode of the image forming apparatus 1 to transition from the second power-saving mode to the first power-saving mode (step S105).

Subsequently to the processing in step S105, the controller 21 acquires information about the point in time when the operation mode had transitioned to the first power-saving mode and defines the point in time as a sleep return time (step S106).

Subsequently to the processing in step S106, the controller 21 determines whether or not the status of access to the storage device (the storage device 35 in the case of the image forming apparatus 1) is the predetermined highly frequent access status where the frequency of access to the storage device is high (step S107). In this embodiment, the controller 21 determines, based on the determination in step S120 of whether or not the frequency of access to the storage device is high, whether or not the status of access to the storage device is the highly frequent access status. For example, when the frequency of access to the storage device is determined to be low a predetermined threshold number of determinations (for example, three determinations) consecutively, the controller 21 determines that the status of access to the storage device is not the highly frequent access status. For another example, when the frequency of access to the storage device is determined to be low a predetermined threshold number of determinations (for example, three determinations) or more out of a predetermined number of latest determinations (for example, five determinations), the controller 21 determines that the status of access to the storage device is not the highly frequent access status.

When in the determination processing in step S107 the controller 21 determines that the status of access to the storage device is the highly frequent access status (YES in S107), the controller 21 turns, as for, among the components of the image forming apparatus 1 the power supplies to which are to be on in the first power-saving mode, components the power supplies to which are off (such as the storage device 35 as the storage device defined in CLAIMS), the power supplies to the components from off to on to run the components (step S108) and goes to step S110.

When in the determination processing in step S107 the controller 21 determines that the status of access to the storage device is not the highly frequent access status (NO in S107), the controller 21 turns, as for, among the components of the image forming apparatus 1 the power supplies to which are to be on in the first power-saving mode and other than the storage device 35 as the storage device defined in CLAIMS, components the power supplies to which are off, the power supplies to the components from off to on to run the components (step S109) and goes to step S110. In step S109, the controller 21 keeps the power supply to the storage device 35 as the storage device defined in CLAIMS from being turned on, i.e., keeps it in an off state, and thus the storage device 35 as the storage device defined in CLAIMS does not run.

The controller 21 calculates the operating period during which the image forming apparatus 1 has operated in the second power-saving mode from the sleep reference time to the sleep return time (i.e., the operating period = (the sleep return time) minus (the sleep reference time) )(step S110).

Subsequently to step S110, the controller 21 determines whether or not the operating period of the operation in the second power-saving mode is equal to or less than the predetermined second criterion threshold (30 (minutes) in this embodiment) (step S111). The second criterion threshold is an example of the criterion threshold defined in CLAIMS.

When in the determination processing in step S111 the controller 21 determines that the operating period is neither equal to nor less than the second criterion threshold (NO in S111), the controller 21 sets the timer to the predetermined 2-1-st timer period (1 (second) in this embodiment) (step S112). The 2-1-st timer period is an example of the first reference period defined in CLAIMS. Subsequently to the processing in S112, the controller 21 sets N=0 (step S113) and goes to the processing in step S116.

On the other hand, when in the determination processing in step S111 the controller 21 determines that the operating period is equal to or less than the second criterion threshold (YES in S111), the controller 21 increments the value of N by 1 (step S114). Subsequently, the controller 21 sets the timer to the predetermined 2-2-nd timer period (N×5 (minutes) in this embodiment) longer than the 2-1-st timer period (step S115) and goes to the processing in step S116. However, when in step S115 N×5 (minutes) exceeds 30 (minutes), the controller 21 sets the 2-2-nd timer period to 30 minutes. The 2-2-nd timer period is an example of the second reference period defined in CLAIMS.

The controller 21 determines whether or not the storage device (the storage device 35 in the case of the image forming apparatus 1) is being accessed (step S116). When in the determination processing in step S116 the controller 21 determines that the storage device is not being accessed (NO in S116), the controller 21 goes to the processing in step S120.

When in the determination processing in step S116 the controller 21 determines that the storage device is being accessed (YES in S116), the controller 21 determines whether or not the storage device (the storage device 35 in the case of the image forming apparatus 1) has already run (step S117). When in the determination processing in step S117 the controller 21 determines that the storage device has already run (YES in S117), the controller 21 goes to the processing in step S119.

When in the determination processing in step S117 the controller 21 determines that the storage device (the storage device 35 in the case of the image forming apparatus 1) has not yet run (NO in S117), the controller 21 turns the power supply to the storage device (the storage device 35 in the case of the image forming apparatus 1) on to run the storage device (step S118) and goes to the processing in step S119.

The controller 21 acquires information about the point in time when the storage device has been accessed. During the operation in the first power-saving mode as a result of a first transition from the second power-saving mode to the first power-saving mode, the controller 21 defines the time point as an access reference time (step S119). During the operation in the first power-saving mode as a result of a second or later transition from the second power-saving mode to the first power-saving mode, the controller 21 defines the time point as an access time (step S119). Then, the controller 21 goes to the processing in step S120.

The controller 21 determines whether the frequency of access to the storage device (the storage device 35 in the case of the image forming apparatus 1) is high or low (step S120).

In step S120, during operation in the first power-saving mode as a result of the first transition from the second power-saving mode to the first power-saving mode, the controller 21 determines, based on the time interval from the sleep return time (the sleep return time as a result of the processing in step S106 during the current operation in the first power-saving mode) to the access reference time (the access reference time as a result of the processing in step S119 during the current operation in the first power-saving mode), whether the frequency of access to the storage device is high or low. For example, when the time interval is not more than a predetermined value, the controller 21 determines that the frequency of access to the storage device is high. When the time interval is more than the predetermined value, the controller 21 determines that the frequency of access to the storage device is low. However, for example, when the storage device is not being accessed during the current operation in the first power-saving mode, the controller 21 may determine that the frequency of access to the storage device is low.

In step S120, during operation in the first power-saving mode as a result of the second or later transition from the second power-saving mode to the first power-saving mode, the controller 21 determines, based on the time interval from the sleep return time (the sleep return time as a result of the processing in step S106 during the current operation in the first power-saving mode) to the access reference time (the access reference time as a result of the processing in step S119 during the current operation in the first power-saving mode) and the access time interval to the access reference time (the access reference time as a result of the processing in step S121 in the first power-saving mode where the storage device has been accessed before the transition to the current first power-saving mode) to the access time as a result of the processing in step S119 during the current operation in the first power-saving mode), whether the frequency of access to the storage device is high or low. For example, when the time interval is not more than a predetermined first value and/or when the access time interval is not more than a predetermined second value, the controller 21 determines that the frequency of access to the storage device is high. In the other cases, the controller 21 determines that the frequency of access to the storage device is low. However, for example, when the storage device is not being accessed during the current operation in the first power-saving mode, the controller 21 may determine that the frequency of access to the storage device is low.

As just described, during operation in the first power-saving mode as a result of the second or later transition from the second power-saving mode to the first power-saving mode, the controller 21 determines, based on the time interval from the sleep return time to the access reference time and the access time interval to the access reference time to the access time, whether the frequency of access to the storage device is high or low. However, based on what it is determined whether the frequency of access to the storage device is high or low is not limited to the above. Whether the frequency of access to the storage device is high or low may be determined based on the time interval from the sleep return time to the access reference time or based on the access time interval from the access reference time to the access time. In the former case, for example, when the time interval is not more than the predetermined first value, the controller 21 may determine that the frequency of access to the storage device is high. When the time interval is more than the predetermined first value, the controller 21 may determine that the frequency of access to the storage device is low. In addition, when the storage device is not being accessed during the current operation in the first power-saving mode, the controller 21 may determine that the frequency of access to the storage device is low. In the latter case, for example, when the access time interval is not more than the predetermined second value, the controller 21 may determine that the frequency of access to the storage device is high. When the access time interval is more than the predetermined second value, the controller 21 may determine that the frequency of access to the storage device is low. In addition, when the storage device is not being accessed during the current operation in the first power-saving mode, the controller 21 may determine that the frequency of access to the storage device is low.

Subsequently to the processing in step S120, during operation in the first power-saving mode as a result of the second or later transition from the second power-saving mode to the first power-saving mode, the controller 21 defines the point in time when the storage device has been accessed (the access time as a result of the processing in step S119) as an access reference time (step S121).

Subsequently to the processing in step S121, the controller 21 starts the timer at the start of the waiting period during which it has not yet executed the processing accompanying the second to first transition event. Then, when the 2-1-st timer period set in step S112 or the 2-2-nd timer period set in step S115 has passed to reach a time-out (step S122), the controller 21 goes back to the processing in step S102 and, in step S102, allows the operation mode of the image forming apparatus 1 to transition from the first power-saving mode back to the second power-saving mode and, as for, among the predetermined components of the image forming apparatus 1 the power supplies to which are to be off in the second power-saving mode, the components the power supplies to which are on (such as the storage device 35), the controller 21 turns the power supplies to the components from on to off. Furthermore, when a second to first transition event occurs, the controller 21 resets the timer and sets the 2-1-st timer period or the 2-2-nd timer period anew.

In the second embodiment, the same effects as in the first embodiment can be obtained.

There are cases where the image forming apparatus 1 transitions from the first power-saving mode to the second power-saving mode without access to the storage device (the storage device 35 in the case of the image forming apparatus 1) during the first power-saving mode to which the operation mode has transitioned from the second power-saving mode.

In the second embodiment, in the case where the status of access to the storage device (the storage device 35 in the case of the image forming apparatus 1) is out of the highly frequent access status, the power supply to the storage device is turned on at the time point when the storage device has been accessed after the transition from the second power-saving mode to the first power-saving mode and, thus, the storage device is run. Thus, in the case where the image forming apparatus 1 has transitioned from the first power-saving mode to the second power-saving mode without access to the storage device during the first power-saving mode to which the operation mode has transitioned from the second power-saving mode, the power supply to the storage device remains off, which enables the number of turn-ons of the power supply to the storage device and the number of turn-offs thereof to be reduced and, as a result, enables the image forming apparatus 1 equipped with the storage device 35 to be extended in life.

Furthermore, in the second embodiment, in the case where the status of access to the storage device (the storage device 35 in the case of the image forming apparatus 1) is the highly frequent access status, the power supply to the storage device is turned on at the transition from the second power-saving mode to the first power-saving mode to run the storage device. Thus, the storage device can be promptly accessed.

In the general technique described previously, the reference period obtained by dividing the product life of the electronic device with the storage device by the guaranteed power on-off times for the storage device is a fixed value. Therefore, the on/off control of the power supply to the storage device cannot meet changes in operation status of the electronic device with the storage device.

The present disclosure has been made in view of the foregoing circumstances and can perform the on/off control of the power supply to the storage device in the electronic device, thus extending the life of the electronic device with the storage device and reducing the power consumption thereof.

The present disclosure is not limited to the structures and configurations in the above first and second embodiments and can be modified in various ways. Furthermore, the structure, configuration, and processing of the above first embodiment described with reference to FIGS. 1 to 5 and the structure, configuration, and processing of the above second embodiment described with reference to FIGS. 6 and 7 are merely illustrative of the present disclosure and are not intended to limit the present disclosure to them.

While the present disclosure has been described in detail with reference to the embodiments thereof, it would be apparent to those skilled in the art that the various changes and modifications may be made therein within the scope defined by the appended claims.

What is claimed is:

1. An electronic device comprising:
a storage device; and
a control device comprising a processor and functioning, through the processor executing a control program, as a controller that controls an operation of the storage device,
wherein the controller sets the electronic device to an operation mode selected from at least a first mode where a power supply to the storage device is allowed to be on and a second mode where the power supply to the storage device is off,
upon occurrence of a predetermined event leading to transition from the second mode to the first mode when the operation mode of the electronic device is the second mode, the controller allows the operation mode to transition from the second mode to the first mode,
when, during operation of the electronic device in the first mode, a waiting period for which processing accompanying the event remains unexecuted reaches a predetermined threshold value, the controller allows the operation mode to transition from the first mode to the second mode,
when the controller allows the operation mode to transition from the second mode to the first mode and determines that an operating period of the operation in the second mode just previous to transition to the first mode has exceeded a predetermined criterion threshold, the controller sets the threshold value to a predetermined value serving as a first reference period, and
when the controller allows the operation mode to transition from the second mode to the first mode and determines that the operating period of the operation in the second mode just previous to the transition to the first mode is not more than the criterion threshold, the controller sets the threshold value to a predetermined value serving as a second reference period longer than the first reference period.

2. The electronic device according to claim 1, wherein
when the controller allows the operation mode to make a transition from the second mode to the first mode and determines that a status of access to the storage device is a predetermined highly frequent access status where a frequency of access to the storage device is high, the controller turns the power supply to the storage device on upon the transition of the operation mode from the second mode to the first mode and thus runs the storage device, and
when the controller allows the operation mode to make a transition from the second mode to the first mode and determines that the status of access to the storage device is out of the highly frequent access status, the controller turns the power supply to the storage device on at a time when the storage device has been accessed after the transition of the operation mode from the second mode to the first mode and during subsequent operation of the electronic device in the first mode and thus runs the storage device.

3. The electronic device according to claim 2, wherein
during operation of the electronic device in the first mode as a result of transition from the second mode to the first mode, the controller detects a time interval to a first access to the storage device since the transition to the first mode,
when the time interval detected during the operation in the first mode as the result of transition from the second mode to the first mode is not more than a predetermined value, the controller determines that the frequency of access to the storage device is high, and
when the detected time interval is more than the predetermined value, the controller determines that the frequency of access to the storage device is low.

4. The electronic device according to claim 1, wherein in a case where the waiting period reaches the second reference period, the controller thus allows the operation mode to transition from the first mode to the second mode, and then the controller allows the operation mode to transition from the second mode back to the first mode upon occurrence of the predetermined event, when the controller determines that the operating period of the operation in the second mode just previous to the transition to the first mode is not more than the criterion threshold, the controller sets the threshold value to a value serving as the second reference period longer than the previous second reference period.

5. An electronic device comprising:
a storage device; and
a control device comprising a processor and functioning, through the processor executing a control program, as a controller that controls an operation of the storage device,
wherein the controller sets the electronic device to an operation mode selected from at least a first mode where a power supply to the storage device is allowed to be on and a second mode where the power supply to the storage device is off,
upon occurrence of a predetermined event leading to transition from the second mode to the first mode when the operation mode of the electronic device is the second mode, the controller allows the operation mode to transition from the second mode to the first mode,
when the controller allows the operation mode to make a transition from the second mode to the first mode and determines that a status of access to the storage device is a predetermined highly frequent access status where a frequency of access to the storage device is high, the controller turns the power supply to the storage device on upon the transition of the operation mode from the second mode to the first mode and thus runs the storage device, and
when the controller allows the operation mode to make a transition from the second mode to the first mode and determines that the status of access to the storage device is out of the highly frequent access status, the controller turns the power supply to the storage device on at a time when the storage device has been accessed after the transition of the operation mode from the second mode to the first mode and during subsequent operation of the electronic device in the first mode and thus runs the storage device.

6. The electronic device according to claim 1, wherein the storage device is an SSD (solid state drive) or an HDD (hard disk drive).
